(19) United States
(12) Patent Application Publication
(10) Pub. No.: US 2006/0277189 A1
(43) Pub. Date: Dec. 7, 2006

(54) Translation of search result display elements

(75) Inventor: Andrew Cencini, Seattle, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/143,000

(22) Filed: Jun. 2, 2005

(51) Int. Cl. G06F 17/30

(52) U.S. Cl. 707/10

(57) ABSTRACT

A system and a method for presenting search results to a user. A search component selects content in response to a search. A search result description generator utilizes a portion of the content to generate descriptions of the search results. A description translator component translates at least one of the descriptions into a desired language, and a search result renderer enables display of the descriptions in a selected manner.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

In recent years, computer users have become more and more reliant upon computers to store and present a wide range of content including news, research, and entertainment. For example, the Internet, through its billions of Web pages, provides a vast and quickly growing library of information and resources.

In order to find desired content, computer users often make use of search utilities. For example, Internet search engines are well known in the art, and commonly known commercial engines include those provided by Google, Yahoo, and Microsoft Network (MSN™). In response to a user's search query, an Internet search engine will generally provide search results that list various Web pages that may contain desired content. These search results often include captions associated with the Web pages that describe the pages or show a portion of the pages' content.

Many of today's commercial search engines rely on common techniques to provide search results. An Internet search engine generally has a substantial database where content from billions of Web pages is stored and indexed. To gather this Web page data, a utility known as a “Web crawler” scours the Internet and pulls in text and data from known Web sites.

After the Web crawler relays the content of a Web page to the database, the text is parsed and various indices are created. These indices catalog the location of various occurrences of each word on the stored Web pages. An Internet search engine can then utilize the indices to find Web pages that contain desired search terms.

However, often a user's search will yield results that include various Web pages composed in foreign languages. For example, an English language search may return Web page descriptions in Japanese or Italian. If the user is unable to read these languages, the Japanese and Italian results will be incomprehensible to the user and will be disregarded. Thus, currently available search engines are limited in that they do not provide all search results composed in accordance with a user's language. By not providing all results in a user's language, the user may ignore highly relevant documents because of an inability to comprehend information associated with the foreign language results. Accordingly, there is a need for improved techniques for presenting search results to a user.

### SUMMARY

The present invention meets the above needs and overcomes one or more deficiencies in the prior art by providing a system and method for presenting search results to a user. In one aspect of the present invention, a system provides search results descriptions composed in a desired language. The search results are obtained through a search over a computer network, and the system includes a search component that selects content in response to the search. A search result description generator utilizes a portion of the content to generate descriptions of the search results. A description translator component translates at least one of the descriptions into the desired language, and a search result renderer enables display of the descriptions in a selected manner.

In another aspect of the present invention, a computerized method for implementing a search engine is provided. The method presents a listing of document descriptions to a user in a desired language. A search having one or more search terms is received from a user, and one or more documents are identified in response to the search. The documents are utilized to generate descriptions for each document. One or more documents are translated into the desired language, and the translated content is presented to the user along with the document descriptions.

In yet another aspect of the present invention, one or more computer-readable media is provided. The media includes computer-usable instructions embodied thereon for performing a method of presenting search results composed in a desired language. The search results are generated in response to a search over a computer network. Each document not composed in the desired language is identified and modified. This modification includes translating at least a portion of the document's content into the desired language. Captions describing the documents are generated and presented to the user.

### BRIEF DESCRIPTION OF THE SEVERAL VIEWS OF THE DRAWINGS

The present invention is described in detail below with reference to the attached drawing figures, wherein:

FIG. 1 is a block diagram of a computing environment suitable for use in implementing the present invention;

FIG. 2 is a block diagram of a search engine system in accordance with an embodiment of the present invention;

FIG. 3 is a block diagram of a system for providing search results descriptions in accordance with an embodiment of the present invention;

FIG. 4 is a flow diagram showing a method for providing a search engine in accordance with an embodiment of the present invention;

FIGS. 5A and 5B are a flow diagram that illustrates a method for providing a search engine in accordance with an embodiment of the present invention; and

FIG. 6 is a flow diagram showing a method for presenting content to a user in accordance with an embodiment of the present invention.

### DETAILED DESCRIPTION

The subject matter of the present invention is described with specificity to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described. Further, the present invention is described in detail below with reference to the attached drawing figures, which are incorporated in their entirety by reference herein.

The present invention provides improved systems and methods for presenting search results to a user. The invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including hand-held devices, multiprocessor systems, microprocessor-based or programmable-consumer electronics, minicomputers, mainframe computers, and the like. Any number of computer-systems and computer networks are acceptable for use with the present invention. The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

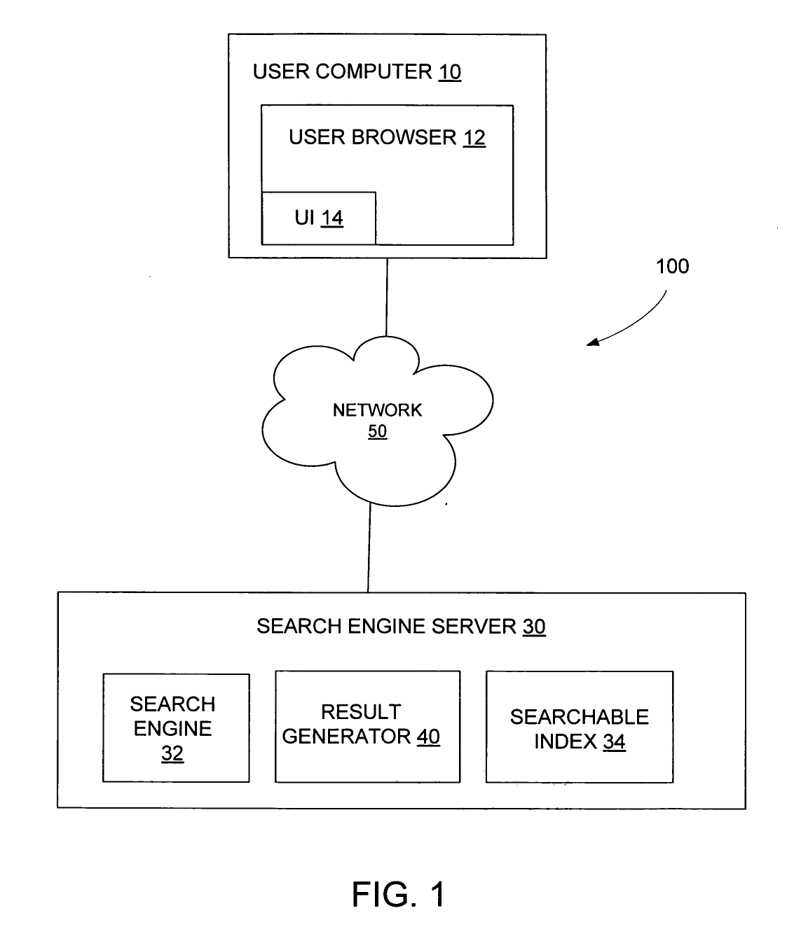

FIG. 1 illustrates a system 100 which represents an exemplary environment in which the present invention may be practiced. The system 100 including a user computer 10 having a user browser 12 accessible through a user interface (UI) 14. The user computer 10 may be connected over a network 50 and a search engine server 30. The search engine server 30 may include a search engine 32, a searchable index 34, and a search result description generator 40. Other components that are not shown may also be included. In operation, the search engine 32 may traverse the searchable index 34 and implement the result generator 40 to generate results in accordance with settings of the server 30. In operation, the user submits a query through the user browser 12 and receives results on the browser 12 as well.

As previously mentioned, the current invention relates to an improved system and method for presenting search results that describe a set of electronic documents. As will be appreciated by those skilled in the art, electronic documents may be any set of content stored on computer readable media. For example, computer items/files such as word processor documents, spreadsheets, or Web pages may be considered electronic documents. Further, any set of text or binary data may be considered an electronic document. The electronic documents may be stored in a single database/data store or in multiple locations.

The present invention may be implemented with a search engine capable of searching text and/or content. Those skilled in the art will recognize that the present invention may be implemented with any number of searching utilities. For example, an Internet search engine or a database search engine may include the present invention. These search engines are well known in the art, and commercially available engines share many similar processes.

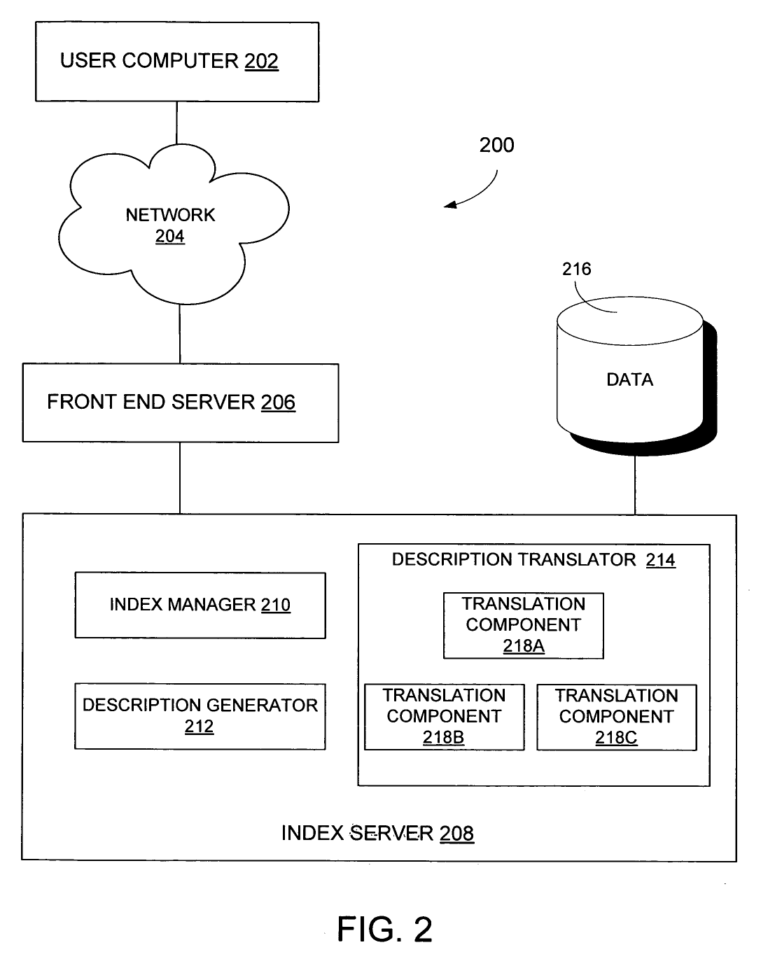

FIG. 2 shows a system 200 that includes a search engine in accordance with the present invention. Those skilled in the art will recognize that the system 200 provides only one of many possible search engine systems and that numerous search engine systems are acceptable for use with the present invention.

The system 200 includes a user computer 202 that is in communication with a front-end server 206 via a network 204. The user computer 202 may be any computing device capable of accessing the network 204. Further, the network 204 may be any variety of different networks including the Internet or an intranet. Those skilled in the art will appreciate that the user computer 202 may be equated to the user computer 10 of FIG. 1, while the network 204 may be equated to the network 50 of FIG. 1.

According to one embodiment, the front-end server 206 provides an interface between the user and any number of additional servers in the system 200. For example, the front-end server 206 may receive a search query from the user computer 202 via the network 204. The front-end server 206 may process the query and/or communicate the query to additional servers. After receiving the query results, the front-end server 206 may aid in communicating the results to the user computer 202. The front-end server 206 may also aid in determining which language a user desires for the returned search results. Those skilled in the art will appreciate that the front-end server 206 may perform any number of processes related to providing an interface between the user computer 202 and other devices of the system 200.

The front-end server 206 is in communication with an index server 208. The index server 208 is configured to receive a search query from the front-end server 206 and to return results to the query. The index server 208 may include any number of modules related to generating search results. For example, the index server 208 may include an index manager 210, a description generator 212 and a description translator 214. Further, those skilled in the art will appreciate that the search engine server 30 of FIG. 1 may also include the elements of the index server 208.

The index manager 210 may be configured to access a data store 216 and identify the most relevant electronic documents in the data store 216. Those skilled in the art will appreciate that the index manager 210 may be implemented along with any number of search utilities and that the results to a given query may be identified and ranked in accordance with any number of different heuristics. For example, in one embodiment the data store 216 includes a substantial database in which the content from billions of Web pages is stored. As known to those skilled in the art, this content is generally retrieved from the Internet by a utility known as a Web crawler, which scours the Internet and relays the text of known Web sites to the data store. The Web crawler may also send additional information about a document to the data store. This information may include title information, where the document may be found (i.e. URL) and the language of the document. Web crawlers may be designed to efficiently update the data store by revisiting the known websites. Further, Web crawlers are capable of finding previously unexamined Web pages by following hyperlinks to such pages. Once the Web crawler has relayed the content of the numerous Web pages to the data store 216, the words from the Web pages are indexed. The index manager 210 is configured to access this index to identify the most relevant documents to a given query.

Once the most relevant documents are identified, information related to these documents is communicated from the index manager 210 to the description generator 212. This information may include a portion of the documents' text and other metadata associated with the documents, including language information. In some embodiments, the description generator 212 may also access the data store 216 to gather information about the identified documents. The description generator 212 is configured to utilize the information describing the identified documents to generate a description for display to the user. As well known in the art, the results to a query may include various information to aid the user's review of the results. For example, the description of a document may include the title of the document and some contextual information that summarizes the document based on the user's query. Accordingly, the description generator 212 may be configured to extract the title of a document and to extract a contextual description of the document. Additional information appropriate for display to the user may also be presented. For example, occurrences of search terms in the contextual description may be displayed in bold text.

For instances when the index manager 210 identifies documents written in a language that does not match the user's language, the description translator 214 is utilized. The description translator 214 is configured to receive information related to such foreign language documents. This information may include the language of the document as stored in the data store 216 or within the content itself. Translation components 218A, 218B and 218C may aid in the translation, and each component may provide support for a different language. Theses components 218A-C may add language support modularly (i.e. be pluggable), or they also may be built into the translator 214.

After determining in which language a document is composed, the description translator 214 translates at least a portion of the document into the user's language. For example, the entire text of a document may be translated into a user's language. Following translation, a description may be generated from the translated content. In another embodiment, the description translator 214 is utilized to translate a caption generated by the deception generator 212. As previously discussed, the caption/description may include the title of the documents and a contextual description that highlights keywords. In either case, once the translation is complete, the translated title, contextual description and any other display elements are communicated to the user via the network 204. Optionally, the displayed results may include a visual indication notifying the user of the translation.

Those skilled in the art will recognize that the forgoing description of the system 200 is provided as an example and that any number of different devices and dataflows may be used in accordance with the present invention. For example, a large-scale system may have numerous front-end servers and index servers. For example, the index server that generates the search results may be different than the server that generates the captions. The description translator 214 also may be on different servers, including the front-end server 206.

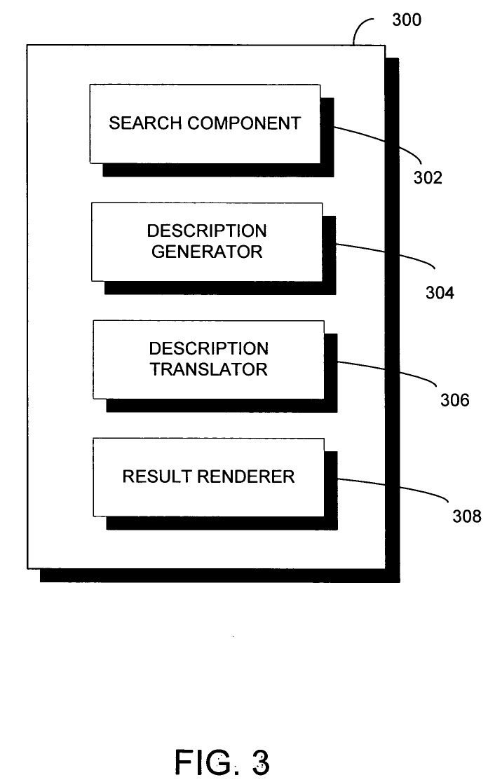

FIG. 3 illustrates a system 300 for providing search results descriptions composed in a desired language. The system 300 may be practiced along with any variety of search utilities, including searches over a computer network. The system 300 includes a search component 302 that is configured to select particular content in response to a user's search. The search component 302 may receive the search, scour a data store and identify the most relevant documents in the data store. Those skilled in the art will recognize that any number of search techniques may be used in the selection of content which is responsive to a user's query and that a variety of these techniques are acceptable for use with the present invention.

The system 300 also includes a search result description generator 304 for utilizing the selected content to generate descriptions of the search results. The selected content may be communicated to the search result description generator 304 by other components, or the generator 304 may directly access the data store. In one embodiment, the search result description generator 304 individually considers each document selected by the search component 302. The search result description generator 304 extracts information from the documents including document titles and contextual descriptions of the documents. Those skilled in the art will recognize that any portion of a document may be acceptable for use as part of the document's description.

The system 300 further includes a description translator 306 for translating search result descriptions into a desired language. For example, if a document selected by the search component 302 is not composed in accordance with the user's language, the description translator 306 is operable to translate at least a portion of the document into the user's language. Any number of automated translation techniques known in the art are acceptable for use with the present invention. By using a portion of the translated documents to create each search result description, the search results will be composed in the user's native language. Those skilled in the art will recognize that a variety of automated translation techniques are well known in the art and that any number of these techniques are acceptable for use with the present invention.

According to one embodiment, the description translator 306 translates the content of a foreign language document into the user's native language. Following this translation, either the description translator 306 or the search result description generator 304 can generate a description of the documents with the translated content. In another embodiment, the search result description generator 304 creates a description for each identified document. For the documents not written in the user's native language, the description translator 306 receives the document descriptions associated with these foreign language documents and translates the descriptions into the user's language.

A search result renderer 308 is also included in the system 300. The renderer 308 is configured to display the search result descriptions to the user in a selected manner. Any number of presentation methods is acceptable for use with the present invention, and the search result descriptions may be presented with any combination of additional content. Further, for each description that includes translated content, a visual indicator may notify a user of the translation and of the document's original language.

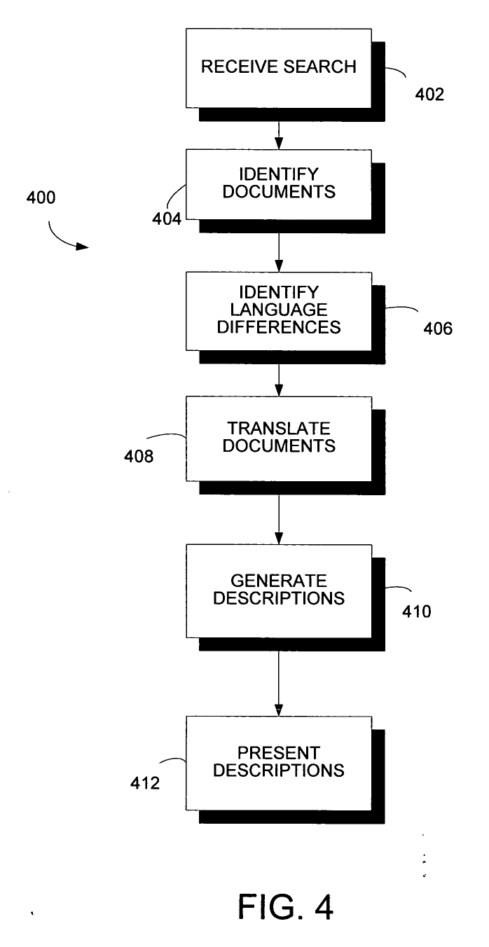

FIG. 4 illustrates a method 400 for providing a search engine that presents a listing of document descriptions to a user in a desired language. At 402, the method 400 receives a search from a user. The search may be received via any number of communication means, including over the Internet. For example, an Internet interface may be provided that allows a user to submit a search to the search engine.

In response to the search, at 404 the method 400 identifies one or more documents. Such identified documents or “hits” may be the most relevant documents related to the user's search. For example, conventional Internet search engines use a data store such as data store 216 in FIG. 2 where the content of billions of Web pages are stored. The data store may also store additional information related to a document such as its language. In response to a user's query, an Internet search engine locates documents and ranks the hits for relevance. Those skilled in the art will recognize that any number of document location or ranking processes may be employed along with the present invention.

At 406, the method 400 determines which of the identified documents are not composed in a desired language. The desired language may be the language spoken by the user, or it may be inferred from various characteristics. For example, the language of the query may indicate a desired language. Other information from the user's computer may also show the user's language. Further, a variety of techniques are acceptable for determining the language of a document. For example, the document may contain metadata specifying a particular language. More complex language analysis also may be employed with the present invention to determine a document's language. Consideration of a location associated with a user or document may indicate a desired language. For example, if a document is stored in a server located in Japan, then it may be assumed that the document is drafted in Japanese. Once the user's and the documents' languages are identified, a comparison is made to determine which documents are not composed in the desired language.

At least a portion of the identified documents are translated into the desired language at 408. In one embodiment, the translation operation is performed on the text of each document whose language differs from the desired language. The entire document may be translated or only a selected portion. For example, only content selected for inclusion in a document description may undergo the translation. It should be noted that the content translation may be performed on any copy of a document's content and that the translated content need not be stored in any particular location. For example, in one embodiment, the translated content is communicated to a service that uses the modified content to generate a caption describing the document. Following the translation, any number of additional operations may be performed with the translated content. For example, the document may be evaluated for relevance, or a document description may be generated. Those skilled in the art will recognize that the translated content may be used in a number of ways to communicate information about a foreign language document to the user.

At 410, the method 400 generates document descriptions for each of the documents. These document descriptions may include content from the selected documents. While any information may be acceptable for inclusion in the document descriptions, information allowing a user to evaluate the documents, such as its title, may be appropriate. A portion of the document's content selected with reference to the search query may also be appropriate. Further, for translated documents, the translated content may be utilized to generate the associated descriptions.

At 412, the method 400 presents the document descriptions to the user. Further, any additional content may be presented to the user with the search results. For example, a visual indicator may distinguish content that was modified by translation. This indicator may also indicate the original language of the content. As will be appreciated by those skilled in the art, the presentation of translated content along with the document descriptions will yield a complete listing of search results in the desired language.

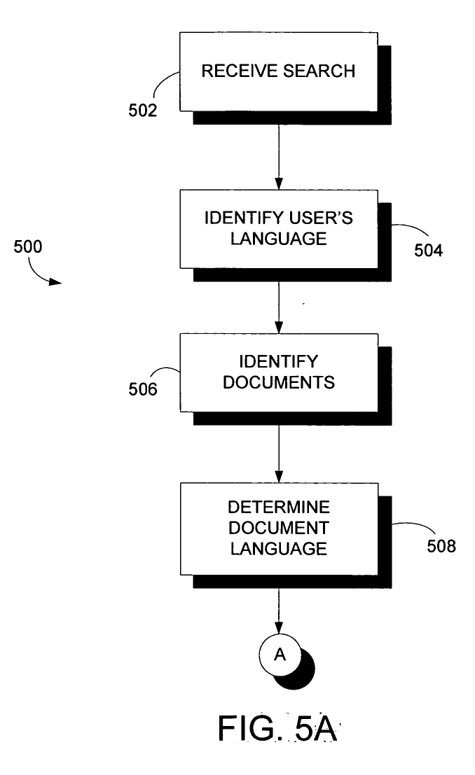

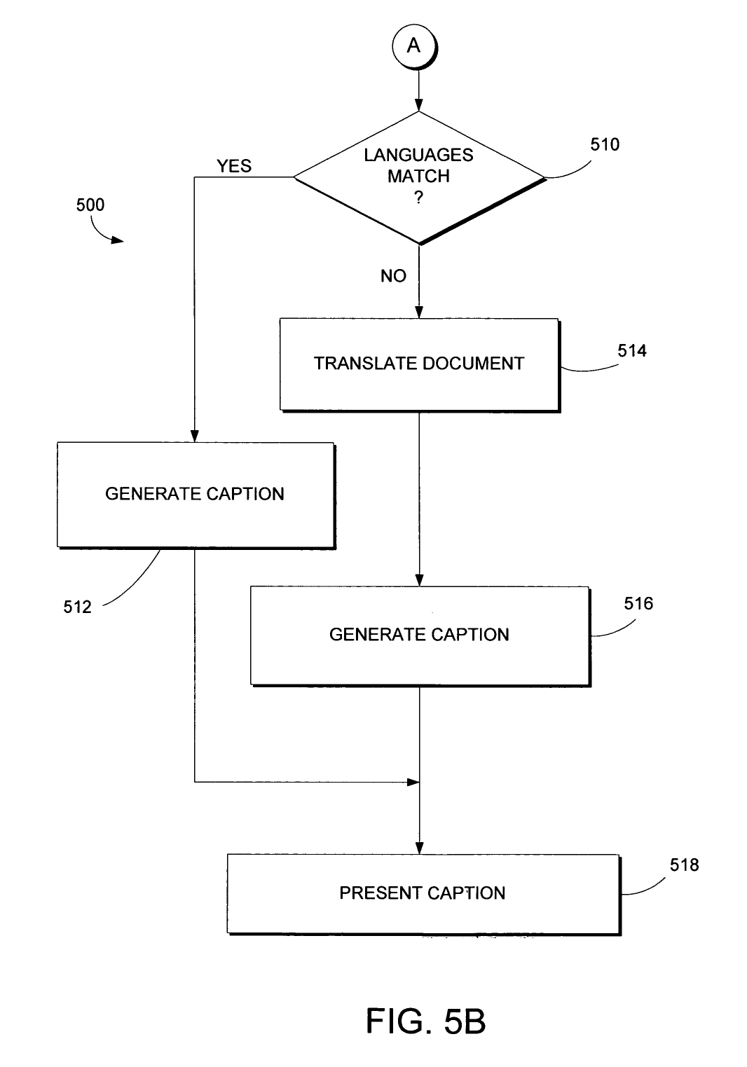

FIGS. 5A and 5B illustrate a method 500 for providing a search engine that presents a listing of captions to a user in a desired language. Referring to FIG. 5A at 502, the method 500 receives a search query from the user. Any number of search platforms are acceptable for use with the present invention, including, for example, an Internet search engine.

The method 500 identifies the user's language at 504. The user may specify a desired language, or the language may be implied from the language of the query. As will be appreciated by those skilled in the art, any number of language detection techniques may be utilized to determine the user's language. These techniques include analyzing other information on a user's computer or the portal the user utilized to submit the search query.

At 506, the method 500 identifies a set of documents that are responsive to the user's query. The identified documents may be the most relevant documents related to the user's search. For example, database search engines are often configured to access a data store where the content of numerous documents are stored, along with additional information related to a document. This additional information may indicate a document's language. Those skilled in the art will recognize that any number of document searching techniques may be employed along with the present invention.

Once the documents are identified, the method 500 determines the language of each of the documents at 508. This language may be stored along with the document in the data store or may be embedded in the document itself. Further the document's language may be inferred. The source of the document or analysis of the content may indicate the document's language. In short, any number of techniques known in the art may be employed to determine the language of a document.

Turning to FIG. 5B at 510, for each document, a comparison is made between the user's language and the document's language. If the languages match, the method 500 generates a caption describing the document at 512. As previously discussed, the caption may include content from the document, as well as other information that may be useful to evaluate the document.

For documents where the user's and document's languages do not match, at 514 the method 500 translates at least a portion of the document into the user's language. Any number of automated translation techniques known in the art are acceptable for use with the present invention. Once the translation is completed, a caption is generated at 516. This caption may include content from the document as translated into the user's language. In accordance with one embodiment, the captions generated at 516 are composed completely with content in the user's language, including a portion of the translated content.

At 518, the method 500 presents the captions generated at 512 and 518 to the user. Those skilled in the art will recognize that any display platform or interface may be acceptable for such presentation. Further, the method 500 may provide additional information associated with search results to the user.

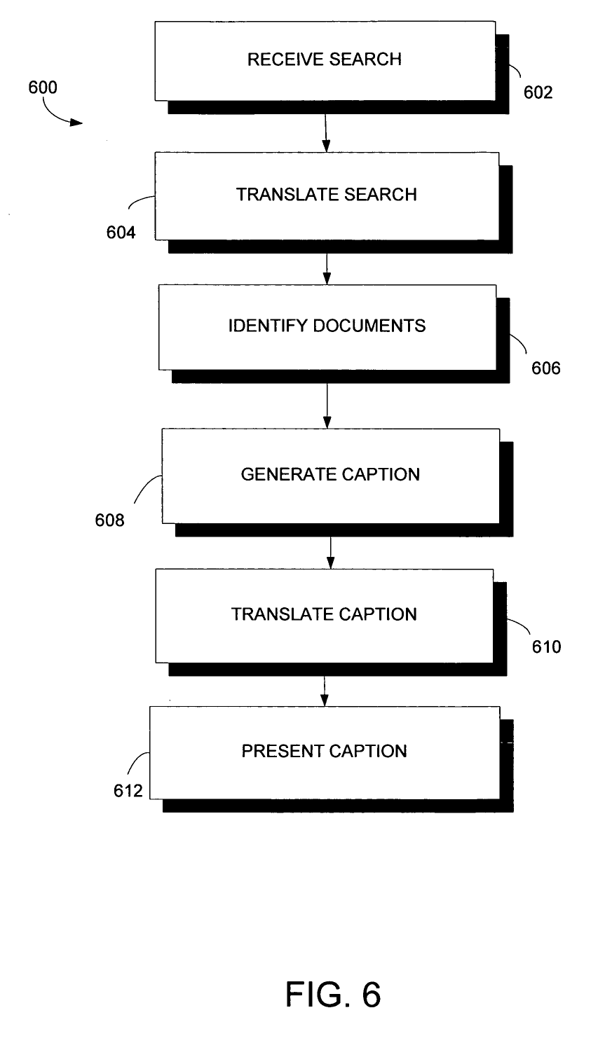

It should be noted that the previously discussed methods and dataflows are provided merely as examples and that any number of techniques for incorporating translation operations into a search engine are contemplated by the present invention. For example, FIG. 6 provides a method 600 for presenting content to a user in accordance with the present invention. As search query is received at 602 from the user. At 604, the search query is translated into a selected language. In one embodiment, the user is given an option to translate the search query into one or more languages. For example, an English-speaking user may have an interest in Italian wines and desire to see Web pages from Italy on Italian wines. If the user cannot speak Italian, he may not be able to draft search queries that return such Italian Web pages. Further, the user would not be able to read the pages once identified. Thus, according to one embodiment, the user may specify a language in which to translate the query.

The translated query is used by the method 600 to identify documents at 606. As will be appreciated by those skilled in the art, because the query is in the selected language, the identified documents are more likely to also be in the selected language. Further, only documents in the selected language may be identified, or the ranking process may only permit documents in that language.

At 608, the method 600 generates captions describing the identified documents. In one embodiment, these captions include content from the documents, and the captions are in the selected language. At 610, the captions are translated into the user's language so that the user may understand the document descriptions, including content from the documents.

The translated captions are presented to the user at 612. Because these captions are composed in the user's language, the user will be able to understand the captions and be able to evaluate the relevance of the various identified documents.

Alternative embodiments and implementations of the present invention will become apparent to those skilled in the art to which it pertains upon review of the specification, including the drawing figures. For example, in one alternative embodiment of the present invention, translation operations may be completed before any ranking process is performed. This order of operations may allow a language-agnostic ranking of the documents to be generated. Accordingly, the scope of the present invention is defined by the appended claims rather than the foregoing description.

The invention claimed is:

1. A system for providing search results descriptions composed in a desired language, the system comprising:
a search component for selecting particular content in response to a search;
a search result description generator for utilizing at least a portion of said particular content to generate one or more search result descriptions;
a description translator component for translating at least one of said one or more search result descriptions into said desired language; and
a search result renderer for enabling display of said one or more search result descriptions in a selected manner.

2. The system of claim 1, wherein said particular content includes one or more electronic documents.

3. The system of claim 1, wherein said particular content includes one or more Web pages.

4. The system of claim 1, wherein said search result description generator utilizes translated content produced by said description translator component to generate said one or more search result descriptions.

5. The system of claim 1, further comprising a user interface component for receiving said search over a network.

6. The system of claim 5, wherein said network is the Internet.

7. The system of claim 5, wherein said user interface component includes an Internet interface.

8. A computerized method for providing a search engine that presents a listing of document descriptions to a user in a desired language, comprising:
receiving a search having one or more search terms from a user;
identifying one or more documents in response to said search;
translating at least a portion of at least one of said one or more documents into said desired language, wherein said translating generates translated content;
utilizing at least a portion of said translated content to generate one or more document descriptions, wherein each of said one or more of document descriptions is associated with at least one of said one or more documents; and
presenting at least a portion of said one or more document descriptions to the user.

9. The computerized method of claim 8, wherein said search is received over the Internet.

10. The computerized method of claim 8, wherein said one or more documents include copies of Web pages stored in a data store.

11. The computerized method of claim 8, wherein at least one of said one or more of document descriptions include text from one of said one or more documents.

12. One or more computer-readable media having computer-useable instructions embodied thereon to perform the method of claim 8.

13. One or more computer-readable media having computer-usable instructions embodied thereon for performing a method of presenting search results composed in a desired language to a user, the method comprising:
selecting a plurality of documents in response to a search;
identifying each of said plurality of documents that are not composed in said desired language;
translating at least a portion of at least one of said plurality of documents into said desired language, wherein said translating generates translated content;
generating a plurality of captions describing at least a portion of said plurality of documents, wherein at least one of said plurality of captions includes said translated content; and
presenting at least a portion of said plurality of captions to the user.

14. The computer-readable media of claim 13, wherein selecting said plurality of documents includes ranking said plurality of documents.

15. The computer-readable media of claim 13, wherein said plurality of documents includes one or more Web pages.

16. The computer-readable media of claim 13, wherein at least a portion of said plurality of captions include a contextual description of at least one of said plurality of documents.

17. The computer-readable media of claim 13, further comprising receiving a user input indicating said desired language.

18. The computer-readable media of claim 13, wherein said presenting includes displaying at least a portion of said translated content.

19. The computer-readable media of claim 13, further comprising providing an Internet-based user interface for receiving said search and for presenting at least a portion of said plurality of captions.
